(19) United States
(12) Patent Application Publication
(10) Pub. No.: US 2014/0172382 A1
(43) Pub. Date: Jun. 19, 2014

(54) Pipeline Network Optimization Using Risk Based Well Production

(71) Applicant: FLUOR TECHNOLOGIES CORPORATION, Aliso Viejo, CA (US)

(72) Inventors: Paul I. Andrews, Fourmarks (GB); John Livermore, Gilford (GB); Paul Garlick, Rainham (GB); Sub Parkash, Plumstead (GB)

(73) Assignee: FLUOR TECHNOLOGIES CORPORATION, Aliso Viejo, CA (US)

(21) Appl. No.: 13/719,948

(22) Filed: Dec. 19, 2012

(51) Int. Cl. G06F 17/50

(52) U.S. Cl. CPC G06F 17/5009
USPC 703/2

(57) ABSTRACT

Systems and methods for pipeline network optimization are presented. The pipeline network can be represented through a flow model, which can include a plurality of modeled wells operatively coupled to production facilities through one or more flowlines. Risk profiles of the one or more flowlines can be determined based on flowline attributes of each flowline and based on a simulation of the flow model that uses production variation in wells connected to the respective flowline as a parameter to generate flow profile of the flowline. Understanding the risk profile of each flowline through a risk metric can help assess the production potential of each flowline and wells associated thereto and optimize the network cost of operation or maintenance.

### FIELD OF THE INVENTION

The field of the invention is pipeline network optimization technologies.

### BACKGROUND

Pipeline networks are typically used in transportation of various materials such as hydrocarbons, oil, CO₂, LPG, liquids, wet gas, LNG, or other products, and involve extensive engineering by connecting one or more wells having such materials to subsea production or processing facilities through one or more flowlines. Flowlines, which are commonly also referred to as pipelines, are used for carrying the material at varying pressures or temperatures. Pipeline networks follow multiple structures and interconnectivity patterns, wherein for instance, one network can have a single well connected to multiple flowlines, wherein another network can have multiple wells connected with multiple flowlines or even a single flowline. In complex network architectures, multiple flowlines take input from multiple wells and therefore performance of each well can impact the flow of material from the corresponding flowline(s). Similarly, change in flowline structure, performance, or functionality, can hamper the efficiency of the wells and hamper their actual production.

As most pipeline networks work at high or varying pressures and temperatures, efficiency of the networks is impacted by attributes relating to flowlines, wells, material being transported, complexity of network, production facilities, among other parameters. It is therefore crucial for pipeline designers or teams responsible for implementation or running of such pipeline networks to assess the flow characteristics of the flowlines or understand the variation in production of the wells to be able to evaluate the risk in terms of the capability of a flowline to support expected flows or in terms of the behavior in flowlines during unexpected flow patterns. Such risk evaluation can help optimize the pipeline network by allowing efficient rearrangement of load, structure, configuration, or function of the wells, flowlines, production facilities, and other elements that are part of the pipeline network.

U.S. patent application 2010/0042458 to Rashid et al. titled “Methods and Systems for Performing Oilfield Production Operations”, filed on Aug. 4, 2009, discusses assessment of well performance based on allocation of multiple resources and determination of optimum allocation using an analytical model, wherein the allocation of applied resources include use of modified Newton's method and other complex algorithms.

International patent application publication WO/2004/046503 to Kosmala et al. titled “Optimizing Well System Models”, filed on Nov. 15, 2002, discusses a controller configured to control reservoir, and/or well network, and/or processing plant models using different optimizer modules. The controller is connected to the reservoir model and the network model and a simulation is run on either or both of the models with a set of input variables to optimize the function of well system. This system merely focuses on optimizing the production and functioning of wells and does not look at the entire pipeline network architecture, including flowlines, as a whole.

U.S. Pat. No. 8,078,444 to Rashid et al. titled “Method for Performing Oilfield Production Operations”, filed on Dec. 6, 2007, discusses allocating a resource amongst various wells by distributing the resource among all wells in a network so as to maximize the liquid/oil rate. Similar to above mentioned references, this system merely focuses on optimizing the production of wells and does not take into consideration the entire pipeline network architecture, including flowlines, and optimizing the system as a whole. Furthermore, Rashid focuses specifically on gas lift technologies and not on general pipeline network structures.

EP 1358619 to Banki et al. titled “Object-Oriented Hydrocarbon Reservoir System Simulation”, filed on Dec. 29, 2000, discusses, an objected oriented hydrocarbon reservoir system, wherein an extensible class hierarchy stores simulation data and comprises two sets of generic classes that represent member variables. Banki proposes simulation of a reservoir system, wherein a facility network model (“FNM”) is developed that extends simulated model (consisting of nodes and flow connections) beyond the reservoir to include nodes and connections for modeling fluid flow in well tubulars and surface production and injection facilities (such as manifolds, pumps, compressors, gathering lines, separators and pipelines).

U.S. Pat. No. 8,170,801 to Foot et al. titled “Determining fluid rate and phase information for a hydrocarbon well using predictive models”, filed on Feb. 21, 2008, discusses, a model to determine rate and phase composition of fluid produced from or injected into wells such that timely alerts can be generated when an anomaly occurs.

The above disclosed materials merely disclose optimization of wells and are directed to improving the production output from the wells by using or more modeling techniques but fail to take into consideration the entire pipeline architecture to optimize the complete architecture for better utilization of resources. These materials also fail to provide a solution to assess the risk that is associated with flowlines when the production of one or more wells connected thereto varies such that the risk and cost involved therein can be minimized and flow characteristics can be improved.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values Similarly, all lists of values should be considered as inclusive of intermediate values unless the context indicates the contrary.

Thus, there is still a need for a pipeline network optimization system and method that can determine risk profile of one or more flowlines for optimizing the pipeline network architecture based on flowline attributes and variation in productivity of multiple wells connected to such flowlines.

### SUMMARY OF THE INVENTION

The inventive subject matter provides systems and methods for determining risk profile of one or more flowlines in a pipeline network to assess the production potential of each flowline and wells associated thereto and optimize the network cost of operation or maintenance. One aspect of the inventive subject matter includes a pipeline network simulation system where a pipeline network can be represented through a flow model, which can include a plurality of modeled wells operatively coupled to production facilities through one or more flowlines. The proposed system can be configured to identify, for each flowline, a plurality of flowline attributes that define the functional or structural characteristics of the flowline. Such attributes can include geographic coordinates, elevation, start point, end point, length, diameter, steady state Mach number M₀, friction coefficient, maximum allowable operating pressure (MAOP), maximum possible flow rate, pressure relief mechanisms, flow time, frictional coefficients, throughput, or other such attributes of the flowline. The identified flowline attributes can be stored in a system memory (e.g., a database, RAM, etc.) along with the flow model where the asset information in the memory can be access by a simulation engine.

The simulation engine can be configured to establish production variations for wells that are part of the model, wherein each well can be connected to one or more flowlines and each flowline can be logically coupled with one or more modeled wells. Production variations typically define parameters that lead to variation in output or productivity from each of the modeled wells and can include seasonal parameters, downtime frequency, variability in rock composition, texture or stress, change in well orientation, degree of stress, change in stress, time variations, or other such parameters. The simulation engine can further be configured to construct a simulation, possibly a Monte Carlo simulation, of the flow model to generate a flow profile for a flowline that connects one or more wells. The flow profile can be representative of the entire modeled system, portions of the flowline network, or even specific to a particular flowline. The simulation of the flow model can be constructed based on the one or more wells and flowlines connected thereto wherein the flow model characterizes the wells through their production variations, flowlines through their attributes, and further characterizes the production facilities. Variability of each well can therefore be incorporated into one or more simulations. Based on the flow model and the variability of each well, one or more risk metrics can be established for each element of the flow model.

Monte Carlo simulation of the flow model can be executed multiple times with varied random input variables and production variables according to the wells' production variations. Multiple runs of the simulation allow for statistical representation of possible risks associated with the elements of the corresponding pipeline network. For example, the simulation can generate a flow profile for each flowline based on the current input parameters of the simulations and on the flowline attributes. The flowline profile can be generated from a single simulation run or from multiple runs to reflect accumulated statistics. The flow profile can be analyzed to understand the behavior of and impact on the flowline when production variations of wells and input variables change.

The simulation engine can be configured to determine a risk metric for each flowline based on the flow profile and the flowline attributes for the concerned flowline. The risk metric can be created or updated after each simulation run such that the updated flow profile can be factored into along with the flowline attributes to generate the risk metric. Thus, the risk metric can indicate a probability that a flowline could support expected flows or might not be able to support expected flows for the simulated network. The risk metric can help provide an understanding or an analysis the behavior of the flowline under dynamically changing characteristics of the wells that the flowline is associated with and its own attributes so that appropriate measures can be taken to control the operation of the flowline. The risk metric can be configured to present risk probability of production for each well over multiple simulations and variations, and can further be configured to present an overall risk probability of production for the flowline based on the behavior of the wells across random input variables. An output device can be configured to present the risk metric of one or more flowlines to help understand, identify, or control risk parameters across wells or can be configured to control flowline attributes for efficient operation of the flowline and the pipeline system. Measurement of risk metrics for each flowline can also help control future costs and project the costs more accurately.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a pipeline network optimization system comprising a flow model database and a simulation engine coupled via a network.

FIG. 2 is a schematic of a flow model comprising wells operatively coupled with processing facilities through flowlines.

FIG. 3 is an example method of pipeline network optimization.

### DETAILED DESCRIPTION

It should be noted that while the following description is drawn to pipeline network optimization systems and methods, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed system. In especially preferred embodiments, the various servers, systems, databases, or interfaces exchange data using standardized protocols or algorithms, possibly based on HTTP, HTTPS, AES, public-private key exchanges, web service APIs, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating signals representative of simulations on flow models and configuring output devices to present risk metric(s) of one or more flowlines. The signals can include one or more packets of input data used for running the simulations and output data received from the simulation that are conveyed over a network (e.g., the Internet, cell phone network, etc.) and received by an electronic device operating as the output device. In response, the electronic device configures itself according to the signal to present flowline risk metric information.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion describes the inventive subject matter with respect to various numbers of records relating to flow models of a pipeline network, flowline attributes, production variation parameters for one or more wells, probability distribution curves, output flow profiles or risk metrics, stored in databases. One skilled in the art will recognize that the inventive subject matter can scale as necessary to any number of items without departing from the inventive subject matter.

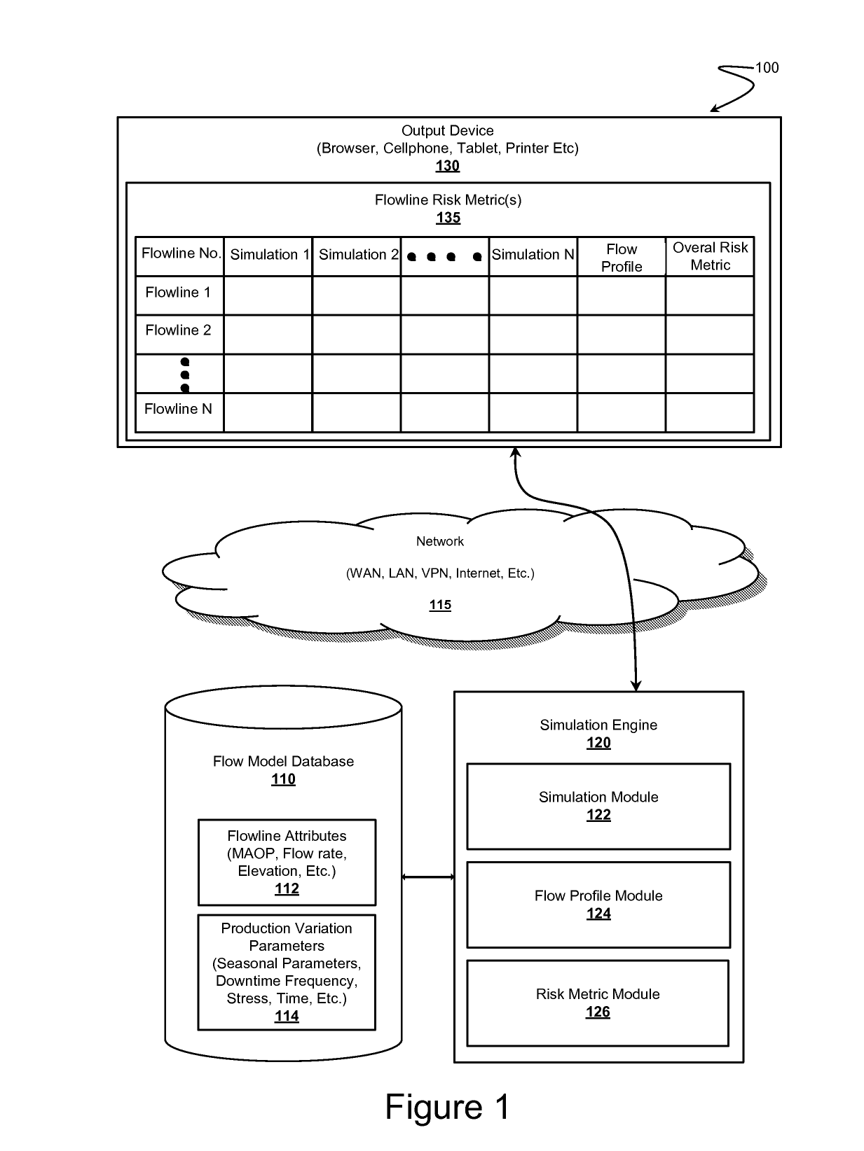

In FIG. 1, pipeline network optimization system 100 comprises of a flow model database 110, a simulation engine 120 operatively coupled to the flow model database 110, and an output device 135. The flow model database 110, the simulation engine 120, and the output device 135 can be operatively connected to each other by a network 115. Network 115 can either be a wired or a wireless network and can comprise a WAN, LAN, VPN, the Internet, cellular telephone network, or other types of network. Applicant has appreciated that a pipeline network system can be represented through a flow model, which can include a plurality of modeled wells logically coupled to production or processing facilities through one or more modeled flowlines. Flow models can be used for designing, analyzing, or optimizing one or more of transportation pipelines, surface gathering, production or operation potential of flowlines, production or operation potential of wells, or behavior of the pipeline network, by changing different parameters such as flow rate, pressure, temperature, flow patterns, energy loss, among like parameters.

Flow model database 110 can be configured to store one or more flowline attributes 112A, 112B . . . 112N, collectively referred to as flowline attributes 112 hereinafter, which define or characterize each modeled flowline in terms of its operation, efficiency, performance, or implementation. The flowline attributes 112 can be associated with one or more flowlines of the flow model, wherein the flowline attributes 112 can include geographic coordinates, elevation, start point, end point, length, diameter, maximum allowable operating pressure (MAOP), maximum possible flow rate, pressure relief mechanisms, flowline equipment parameters such as material of construction, performance parameters of associated equipments such as pumps; separators; compressors; heat exchanger; cooler; or valves, flow time, frictional coefficients, throughput, among other such attributes. Reference to flowlines, hereinafter, can include any structural mechanism used for transportation of material from one end, such as wells, to another end, such as processing or production facilities. Flowline can include a pipeline, cable, fiber optic, pipe, duct, or a power transmission line, among other such structures.

Apart from known or existing flowline attributes 112, multiple other flowline attributes 112 can also be defined based on parameters such as material (such as gas, oil, LPG) for which the pipeline network is being used, complexity of network, production expectations, downtime committed by supplier, or other such parameters. For instance, in case each flowline is connected to multiple wells, and each such well is connected to multiple flowlines, the percentage of gas/liquid material to be distributed by each well to each flowline would govern the performance or operation efficiency of the flowline. Flowline attributes 112 can be different for each flowline within a flow model and can be selected such that they represent the characteristics of the flowline in the best and most accurate manner. For instance, for a flowline A that supplies gas to a processing facility that meets critical requirements, “acceptable downtime” of the flowline can be a flowline attribute 112, but not for another flowline B which feeds to a lower priority processing facility.

Flow model database 110 can be configured to store one or more production variation parameters 114A, 114B . . . 114N, collectively referred to as production variation parameters 114 hereinafter, which define factors that can impact variation in output or productivity from one or more modeled wells and can include seasonal factors, downtime frequency, reservoir pressure, bottomhole pressure, variability in rock composition, texture or stress, change in well orientation, degree of stress, change in stress, time variations, among other such parameters. Production variation parameters 114 can be different for each well within the flow model and depend on the location, purpose, material of construction, expected production, acceptable downtime, among other such parameters of the respective well. A corrosive material of construction, for instance, can significantly impact the production from the well made of such construction and even impact the life of the well or quality of gas/liquid being extracted by the well.

Flow model database 110 can also be configured to store flow characteristic curves for one or more wells of the flow model. Flow characteristic curves can be configured to depict multiple operational characteristics of the wells, such as change in set pressure based on the volume flow. The curves can also present minimum or maximum allowable pressure which can be set for acceptable functioning of each well, beyond which levels, issues such as leakage, physical damage, fluctuation in flow, among others can occur. For instance, a flow characteristic curve can discretely represent gas pressure p (x, t) with respect to gas flow Q (x, t) along a flowline or a combination of wells. Flow characteristic curve can also include probability distribution with respect to the flow rate of the well that it represents. A graph can be used to depict multiple flow characteristic curves for each well, wherein one curve can present volume of flow with respect to time and another curve in the same graph can present the probability of flow distribution across time intervals. The graph can also be configured to display a number of curves for one or more wells, wherein each curve can show multiple variations of a single parameter. For instance, pressure can be represented as minimum pressure, maximum pressure, operating pressure, opening pressure, or calculated pressure through one or more distribution curves.

Flow characteristic curves can be configured to represent probability with respect to flow rates, wherein flow rates for each well can be presented on X axis and probability can be represented on Y axis, and each flow rate can have a corresponding probability of its achievement. For instance, the probability of having a first flow rate of A m³ per day can be 50% and the probability of having a second flow rate of B m³ per day can be 70%, making the second flow rate more likely to be operated on by one or more wells. As flow characteristic curves vary across wells, each well can have a different probability distribution curve with respect to flow rates.

It should be appreciated that the flow model database 110 can be configured to store any other content that forms part of the flow model of the pipeline network. For instance, processing facilities, which are connected with the wells or wellheads through one or more flowlines, can also have attributes such as capacity, extent of parallel processing from multiple flowlines, which when taken into consideration, impact the way the flowlines operate or function. Furthermore, other elements of the pipeline network such as manifold, which connect multiple flowlines; and wellheads, which connect to well(s) can also impact the overall performance of the pipeline network and therefore their attributes or performance parameters can also be stored in flow model database 110.

Simulation engine 120 can be operatively coupled with the flow model database 110 and configured to access data stored in the database 110 to select one or more flowline attributes 112, production variation parameters 114, or flow characteristic curves. Simulation engine 120 can be implemented in a server such as a HTTP server or as a Web service, PaaS, Iaas, SaaS, cloud or the like and can be configured to create a simulation on the flow model of the pipeline network system, which includes modeled wells or modeled flowlines. Simulation can be created on the flow model to assess the behavior or impact on flowlines of the pipeline network when the production variation parameters 114 of one or more wells change. For instance, in case wells W1, W2, and W3 are connected to a flowline F1, a simulation can be constructed on the flow model and production variation parameters 114 can be used as simulation parameters to generate varied and random outputs from each well in every run of the simulation. Based on the outputs from the wells W1, W2, and W3, impact of the output(s) on the performance or operation of the flowline F1 can be assessed after each run of simulation, and a flow profile of the flowline F1 can be generated and consolidated. The flow profile can be modified by averaging or any other suitable technique each time the simulation is run so that varied conditions or change in production parameters from one or more wells can be taken into account for measuring the impact of such variations on the operation or efficiency of the concerned flowline(s).

In an implementation, Monte Carlo simulation can be used by the simulation engine 120 for creating simulation on the flow model, wherein random input variables can be generated by the simulation technique and processed along with the production variation parameters 114 to generate output in terms of volume production from each well during the simulation run Impact of such outputs from one or more wells on the flowline(s) to which they connect can be evaluated or processed to generate a flow profile for each flowline, wherein the flow profile can be changed by averaging or other appropriate techniques each time the simulation is run on the flow models and different outputs are received from the wells.

Simulation engine 120 can be configured to include a simulation module 122, a flow profile module 124, and a risk metric module 126. The simulation module 122 can be configured to choose one or more simulation techniques to be used for creating or running a simulation on the flow model. The simulation module 122 can further be configured to retrieve production variation parameters 114 for each modeled well, also interchangeably referred to as well hereinafter, on which the simulation is intended to be run. It should be appreciated that even though, in a flow model, there can be “n” wells that are operatively connected to “m” flowlines, the simulation can be run on a partial set of wells that connect to a partial set of flowlines. For instance, in case there are 10 flowlines that connect 15 wells to one processing facility, the simulation engine 120 can be configured to compute flow profile and risk metric of only 3 flowlines and assess the impact of production variations and environmental parameters of, for example, 7 wells connected to the 3 flowlines by running the simulation on the 7 wells.

The simulation module 122 can select one or more of known simulation techniques including open-loop simulations, closed loop simulations, GMM estimations, point estimate method, first-order second moment method, first-order reliability method, direct simulation, Monte Carlo simulation, among other known techniques. The simulation module 122 can also be configured to create a completely new simulation technique that is run on the flow model and implemented such that output from multiple wells can be measured in each simulation run through their respective production variation parameters, and such output is used for assessing the impact on the corresponding flowlines. Although the present disclosure is made by taking Monte Carlo simulation as exemplary illustration, any other suitable simulation technique can be used for implementing the simulation module 122. Once the simulation technique has been selected, simulation module 122 can, through or independent of simulation engine 120, select flowlines for which the risk metric or flow profile needs to be computed and subsequently extract wells and their respective production variation parameters that correspond to the selected flowlines. In an implementation, Monte Carlo simulation can be configured to generate one or more random input variables during each run of the simulation, wherein the random input variables can be processed along with one or more production variation parameters of the extracted wells.

During each run of Monte Carlo simulation, production variation parameters 114 can, if desired, be changed for each well such that multiple conditions or situations can be created. Once the production variation parameters 114 have been changed, production output from wells can be monitored after each simulation run by creating multiple boundary level constraints or conditions. For instance, downtime frequency, stress, and time can taken as the production variation parameters 114 in simulation run R1 for well W5, whereas in run R2 only stress and time can be taken as the production variation parameters 114 for the same well W5. Furthermore, ranges for random input variables can also be kept large so that varied production outputs can be expected from the wells over multiple simulation runs. For instance, the range for generated random input variables can be kept from 1-50, wherein higher input variable values can indicate more severe or higher magnitude impact on production variation parameters of the wells. In another instance, in case the random input variable value is 40 and production variation parameter is stress, processing of this input variable value with the production variation parameter can lead to higher stress being applied to the well when compared to when the random input variable value is 20, which can generate relatively lower stress. Ranges can therefore help specify maximum and minimum boundaries for the random numbers being generated by the simulator.

In an embodiment, processing of random input variables with production variation parameters 114 can include multiplying the random input variables values with the production variation parameters 114 and then, based on the outcome of such multiplication, computing production output from the respective well for the particular simulation run and storing the output as an output value. Variation in the range of random input variables can therefore help test the impact or effect of production variation parameters 114 on actual production output of the wells, which can help assess or measure the impact on flowlines that connect to the wells. Simulation module 122 can also be configured to define constraints while generating random input variables or during processing of production variation parameters 114 with the random input variables.

Production variation parameters 114 can also be processed with different random input variables for each simulation run so as to generate more possible production outputs from wells. For instance, increasing the downtime frequency parameter 2 times and stress parameter 4 times would give a different overall production output for the concerned well than when the downtime frequency is increased to 5 times and stress parameter decreased to 2 times. Furthermore, different weights can also be given to each production variation parameter 114 so that apart from random input variables generated during the simulation runs, the assigned weights also impact the overall change in production output for a well during the simulation run. For instance, in case “change in well orientation” has a weight of 0.1 and “change in stress” has a weight of 10, a higher random input variable value processed with well orientation parameter may not significantly impact the well production output but a lower random input variable value processed with stress parameter may significantly impact the well production output.

Simulation module 122 can be configured to run the simulation on the flow model numerous times so as to test production output of modeled wells under all circumstances and varying production variation parameters 114. Each simulation run can change the random input variable associated with each production variation parameter 114 and can also change the number of production variation parameters 114 under consideration so that the wells can be modeled in multiple possible cases and their output performance can be evaluated and sent to flow profile module 124.

Simulation module 122 can also be configured to retrieve flow characteristic curves for one or more wells from flow model database 110, and take them into consideration while generating random input variables. Analysis of pressure or temperature ranges at which the wells produce or change their characteristics, or analysis of probability distribution for a well with respect to its flow rates, can help the simulation module 122 to select appropriate production variation parameters 114 and process them accordingly with the generated random input variables. Simulation module 122 can also be configured to establish the production variation parameters 114 as a function of the flow characteristic curves associated with each of the wells. As a flow characteristic curve can include representation of multiple parameters including nominal pressure, maximum pressure, calculated pressure, pressure loss, maximum flow volume, nominal flow volume, opening pressure, pilot ratio, time, adjustment, leakage, tightness, etc., against each other, production variation parameters 114 can be identified directly from the flow characteristic curve, based on these variables. In an alternate implementation, as new or modified flow characteristic curves can be obtained after every simulation run, each well can be represented in terms of its structural or functional performance through the flow characteristic curves.

The simulation module 122 can also be configured to generate a probability distribution function for each well based on the production output from the well over a period of numerous simulation runs. The probability distribution function can take multiple shapes such as normal, triangle, among others, and can represent the production output (on X axis) with respect to probability of getting such an output (Y axis). Each flow characteristic curve can represent the probability distribution function and multiple such curves can be used to compare performance of the wells or flowlines in the system in terms of factors such as pressure continuity or mass flow preservation.

Flow profile module 124 can be configured to, for a flowline, take production outputs from modeled wells to which the flowline is connected and generate a flow profile for the flowline. The flow profile can be generated for the first time after the first simulation run and thereafter can be updated based on production outputs from wells to which the concerned flowline is connected. The flow profile can include factors that can help assess the impact on the performance or operation of the flowline after each simulation run or assess overall behavior of the flowline after multiple simulation runs. Such parameters can include change in construction material characteristics of the flowline, change in output, change in throughput, stress, pressure, portions of the flowline having maximum or minimum stress, among other such parameters. For instance, the flow profile can indicate that for simulation 1, the stress on the flowline is 75% and change in throughput is 23%, whereas in simulation 2, the stress on the flowline is 87% and change in throughput is 45%, which indicates that the simulation 2 more adversely impacted the performance of the flowline and further reasons for this can be assessed based on the random input variables used in the simulation module 122 and the production variation parameters 114 used for each well connected to the flowline. A further analysis, can for instance, suggest that in the simulation 2, higher stress and throughput was generated by the wells connected to the flowline due to higher input variables, which led to significantly more volume of flow from the wells, thereby effecting more than anticipated stress on the flowline. Such analysis can help understand the upper and lower limits of parameters that define flow rate for a flowline, and helps suggest steps to maintain such parameters within these limits.

Flow profiles of multiple flowlines that are connected to one or more wells can also be processed together to generate a single flow profile of the entire flow model. Such a flow profile for the entire flow model can be used to assess the efficiency in the flow model or identify areas of unexpected performance or stress in the flow model for taking corrective actions across the pipeline network. Parameters that define flow profiles can be different for each flowline and therefore a common flow profile ranking system can be designed such that a quantifiable value can be computed for the flow profile of each flowline. For instance, based on its flow profile, each flowline can be ranked between 1-10, with 10 being the most efficiently working flowline across numerous simulation runs and 1 being the most inefficient flowline. Rankings of all flowlines or of a sub-group thereof can therefore be cumulated or averaged to generate flow profile of the entire flow model.

Monte Carlo simulations can be run numerous times on a flow model, flow profiles of flowlines in the flow model, with each simulation run, improve in their overall interpretation of how their corresponding flowlines react to different situations and give a more accurate representation of the flowline's operations limits, performance limits, or reactions to change in outputs from corresponding wells. In an embodiment, flow profile generated after each simulation run can be stored separately in flow model database 110 and fitted into a linear or time-series model to evaluate change in behavior of the flowline with time or with change in well outputs. Furthermore, weights can also be assigned to flow profiles generated after each simulation run to portray importance of that simulation run. Flow profile of a flowline for a lower priority simulation run would therefore have lower impact during analysis when compared to a flow profile generated for a high priority simulation run.

Flow profile for each flowline can also be obtained based on flow characteristic curves stored in flow model database 110 for each of the wells to which the flowline is connected. As described above, flow characteristic curves can include multiple variables including pressure, physical dimensions, among other like variables that are measured with respect to time, volume or other such parameters. Furthermore, as the production variation parameters 114 can be based on the flow characteristic curves, the flow profile module 124 can, for each flowline and after each simulation run, process the obtained flow characteristic curves of each well connected to the flowline, to achieve the flow profile for the respective flowline.

Flow profile module 124 can also be configured to present the flow profile of a flowline in a table format, wherein in an example, the table presents flow conditions such as downstream pressure, downstream temperature, upstream temperature; fluid property such as oil density at standard condition, specific gas gravity, water density at standard condition, gas oil ratio, or water oil ratio; or impact on tubing parameters such as diameter, roughness, vertical depth, among the such parameters.

Risk metric module 126 can be configured to take flow profile of each flowline along with flowline attributes 112 as inputs and generate a risk metric for the flowline. The risk metric can be created or updated after each simulation run such that the updated flow profile can be factored along with the corresponding flowline attributes of the flowline to generate the risk metric. Risk metric can indicate a probability that a flowline could support expected flows or might not be able to support expected flows for the simulated network. Risk metric can also help understand or analyze the behavior of a flowline under dynamically changing characteristics of wells to which the flowline is associated and its own flowline attributes so that appropriate measures can be taken to control the operation of the flowline. The risk metric can also be configured to present risk probability of production for each well over multiple simulations and variations, and can further be configured to present an overall risk probability of production for the flowline based on the behavior of the wells across random input variables.

Flow profile and flowline attributes for a particular flowline can be represented or incorporated in a defined mathematical equation to obtain the risk metric for the flowline after each simulation. Flow profile generated or updated after each simulation can also be combined with a partial set of flowline attributes to generate the risk metric. In an implementation, risk metric can be generated by assessing the impact of the flow profile of a flowline on one or more flowline attributes such as diameter, pressure created, steady state Mach number M₀, friction coefficient, stress created, among other such flowline attributes. For instance, undesired impact on flowline attributes of a flowline would be more when flow profile for the flowline depicts detrimental effect of the production outputs from the wells on the flowline. Having a complete visibility of random input variables generated, production variation parameters used for wells, production outputs from well after each simulation run, or flow profile generated for each flowline can help select the flowline attributes that are most likely to be affected in performance and such attributes can be used for computing the risk metric of the flowline.

It should be appreciated that boundary level conditions generated by the simulation module 122 on the production variation parameters 114 of one or more wells while running simulation on the flow model can severely impact the performance of the flowlines to which the wells are connected and hence risk metric of the flowlines would represent higher risk of operation of the flowlines under such conditions. For instance, in case during a simulation run numbered 983, the stress is increased by 4 times and downtime frequency is made 0, all the wells would work at highest possible production outputs, making detrimental impact on the flow profile of the flowlines, and as a result, risk metric for the flowline would show high risk during operation of the flowline.

Risk metric can be represented in one or a combination of formats. In one instance, the risk metric can be characterized as a % of risk that the flowline is exposed to, whereas in another instance, the risk metric can be characterized in a range of 1-10, with 10 depicting high risk and 1 depicting low risk. Risk metric can also be represented in a table format or any other graphical representation for efficient and fast analysis of the risk associated a flowline. For instance, the risk metric can be represented in a pie-chart with 5 portions, wherein simulations having quantified risk metric of a flowline between 1-2 can be categorized in first portion, simulations having the risk metric of the flowline between 3-4 can be second portion, simulations having the risk metric of the flowline between 5-6 can be third portion, simulations having the risk metric of the flowline between 7-8 can be fourth portion, and simulations having the risk metric of the flowline between 9-10 can be fifth portion. In such a representation, portion with largest sector size can depict an overall risk range for the respective flowline.

Risk metrics for one or more flowlines can also be combined to assess or interpret the overall risk associated with the flow model. Such overall risk metrics can either be computed after each simulation run, or after a pre-defined time interval, or after the complete simulation is complete. In one implementation, risk metrics of all flowlines can be averaged after say every 1000 simulations and stored as overall risk metrics. In another implementation, weighted risk metrics can be computed for each flowline by assigning weights to each flowline based on its contribution or importance in the flow model. For instance, flowlines 1, 3, and 5 can be more important in function or purpose they serve when compared with flowlines 2 and 4, and therefore higher weights such as 0.5 can be associated with each of 1, 3, and 5 and lower weights such as 0.2 can be associated with flowlines 2 and 4, which enables weighted risk metric computation for each flowline and weighted overall risk metric to be computed for the flow model.

An output device 130 can be configured to present flowline risk metric(s) 135 of one or more flowlines to help understand, identify, or control risk parameters across wells. The flowline risk metric(s) 135 can also be configured to control design or structure of flowline attributes for efficient operation of the flowline or pipeline system. Measurement of risk metrics for each flowline can also help control future costs and project future costs more accurately. The output device 130 can be a web browser, a cell phone, a tablet, a printer, a computer device or other type of suitable device.

Flowline risk metric(s) 135 can include representation of risk metrics for each flowline of a flow model. For each flowline, production outputs from all wells connected to the flowline can be presented together in a single cell, based on which flow profile of the flowline can be generated or updated after each simulation run. For instance, in the exemplary table of FIG. 1 showing the flowline risk metric(s) 135, the second column for Simulation 1 can include production outputs from each well to which the respective flowline is connected. In an alternative embodiment, the second column can also include flow profile generated for the flowline for that specific simulation run. Column “flow profile” can be configured to present updated or overall flow profile for the flowline after each simulation run and can be continuously updated over hours or days during which the simulations are run on the modeled wells. The column “risk metric” can be configured to present overall risk metric for each flowline based on the flow profile and flowline attributes of the concerned flowline.

It should be appreciated that outline of flowline risk metric(s) 135, as presented in FIG. 1, is only an exemplary representation of the flow profile and risk metrics for multiple flowlines of a flow model. Many other representations including graphs, pie-charts, heat maps, contour charts, or any other additional columns or rows detailing overall risk metric for the flow model, overall flow profile for the flow model, list of flowline attributes considered for evaluating risk metric, list of production variation parameters selected for running simulations, among other such factors can be incorporated in the table. In another representation, the flowlines can be grouped together based on their priority, proximity, or commonality between the wells to which they connected, common processing facilities to which they connected, commonality between material of construction or other flowline attributes, among other such factors. Risk metrics for such groups can then be computed to assess the group level risk and issues leading to such risk. Flowlines can also be sorted based on their risk metrics, with a flowline having highest risk being on the top and the one having lowest risk being at the bottom. Such prioritization helps efficient handling of flowlines having highest risk.

Once the risk metrics for each flowline are known, appropriate measures can be taken by users or pipeline designers to analyze factors leading to high risk for the flowline, identify reasons for undesired lift gas rates, identify flowline attributes that are most affected due to high risk, extract simulation runs that caused the risk for the flowline to go beyond a defined threshold, retrieve production variation parameters considered for each simulation run, or other such variables, and process all these variables in a manner such that the root cause of the high risk can be determined and appropriate steps can be suggested for mitigating the risk. Based on the flowline risk metrics 135, the simulation engine 120 can be configured to alter the production variation parameters 114 after each simulation run so that the most optimized or efficient behavior of the flowline as well as of the flow model can be achieved. In another implementation, the simulation engine 120 can be configured to alter the production variation parameters 114 or the flowline attributes 112 or both, after each simulation is run so as to arrive at the most desirable characteristics and flow pattern through the flow model.

The simulation engine 120 can be configured to detect an anomaly or an undesired behavior of any of the wells, flowlines, or any other component of the flow model after each simulation. Such anomalies can relate to physical damage in any of the components, unexpected flow pattern, creation of stress or pressure that is higher than a defined threshold, among other abnormal operational or structural outcomes. When detected, the simulation engine 120 can be configured to apply one or a combination of algorithms that, based on the magnitude, nature, time, location, or reason of anomaly, vary the production variation parameters or flowline attributes to optimize or mitigate the risk caused by the anomaly. The algorithms can either be selected from known techniques such as genetic algorithms, decision trees, neural networks, kNN, naïve Bayes, rule-based systems, supervised machine learning, unsupervised machine learning, linear regression, non-linear regression, logistic regression, among other such techniques, or can be constructed to identify the simulation parameters used for each run and identify the rationale behind the anomaly so as to continually improve the performance of the flow system with each simulation.

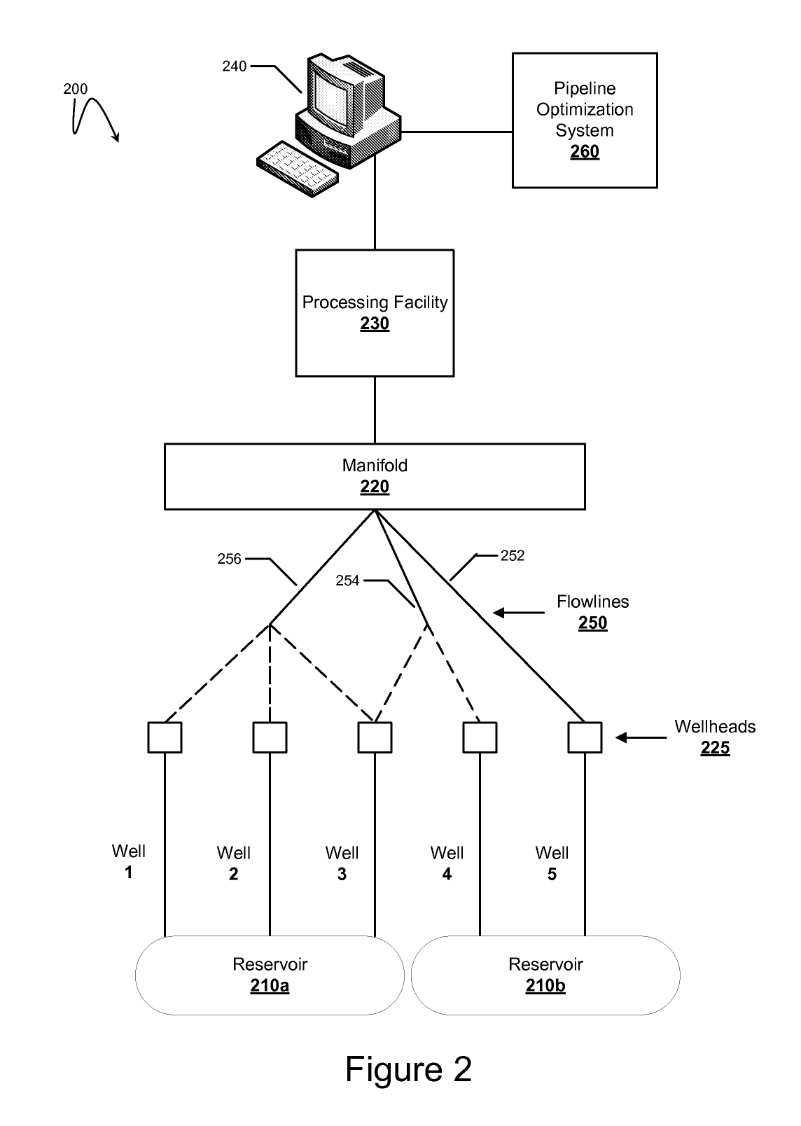

FIG. 2 is a schematic of a flow model 200 comprising wells operatively coupled with a processing facility 230 through flowlines 250. The pipeline network system of FIG. 2, represented by the flow model 200, can include reservoirs 210a and 210b that store the material to be extracted through wells 1-5, and transported through flowlines 252, 254, and 256, collectively referred to as flowlines 250 hereinafter, to manifold 220. Manifold 220 can be operatively connected with the processing facility 230. Processing facility 230 can also be interchangeably referred to as production facility 230 hereinafter.

FIG. 2 represents wells 1-3 connected to reservoir 210a and wells 4-5 connected to reservoir 210b. Each well can be operatively connected to their respective wellheads 225. Wells 1-3, through their corresponding wellheads are connected to flowline 256, wells 3-4 are connected to flowline 254, and well 5 is connected to flowline 252, and therefore, multiple wells can be connected to one flowline 250 and each flowline 250 can be connected to multiple wells. In the present illustration, each flowline 250 serves a single processing facility 230. Each processing facility 230 can be operatively coupled to a pipeline optimization system 260 through one or more computing devices 240, which can be configured to implement the simulation engine 120 and configured to access data from flow model database 110.

In an implementation, pipeline optimization system 260, interchangeably also referred to as pipeline network optimization system 260 hereinafter, can be configured to access production variation parameters 114 of Wells 1-5 through computing device 240. The computing device 240 can then be configured to construct a simulation model, such as a Monte Carlo simulation on flow model 200 so as to generate a flow profile for each of the flowlines 252, 254, and 256. Monte Carlo simulation can be configured to generate multiple random input variables in each simulation run, and process the generated variables with the production variation parameters 114 of each of the wells 1-5 to generate production output from each of the wells.

Each well can have different production variation parameters 114 depending on the flowlines they serve, material of construction, importance in the pipeline network, production capability, acceptable downtime frequency, among other such parameters. For instance, assuming flowline 256 has highest priority as it serves critical areas of industrial application, wells 1-3 can have “downtime frequency” and “production capability” as production variation parameters 114, which might not be applicable as parameters 114 for wells 4-5. Furthermore, well 5 may be used seasonally across defined time periods and not at all times, and therefore “seasonality” can be a production variation parameter 114 for well 5 and not for other wells.

Once production variation parameters 114 for each of the modeled wells have been extracted or identified, random input variables, which can be selected from within a range, can be processed with the production variation parameters 114 of each of the modeled wells and production output from each of the wells can be computed for that simulation run. For instance, assuming for a single simulation run, three production variation parameters P1, P2, and P3, are extracted for well 1, and random input variables, 3, 3.4, and 5.2 are generated by the Monte Carlo simulation. The production variation parameters 114 can be multiplied with the input variables giving P1*3, P2*3.4, and P3*5.2 to define conditions under which production output from the modeled well 1 is to be calculated. Such simulations with different random input variables can be run numerous, say 10000 times, allowing testing of production outputs under varied boundary level and normal conditions. Such production outputs can be taken from each of the modeled wells 1-5 after each simulation.

Once production outputs are generated by one or more modeled wells of a flow model 200 after each simulation run, the pipeline optimization system 260 can be configured to, for each flowline, take production outputs from the modeled wells to which the flowline is connected and generate a flow profile for the flowline. The flow profile can be generated for the first time after the first simulation run and thereafter can be updated based on the production outputs from the wells to which it is connected. The flow profile can include indicators that can help assess the impact on the performance or operation of the flowline after each simulation run or assess the overall behavior of the flowline after multiple simulation runs.

In the present example, flow profiles can be generated for one or more of the flowlines 252, 254, and 256, wherein for flowline 252, production output from its corresponding well 5 can be taken into account to generate flow profile for flowline 252. The flow profile can be updated after each simulation run and therefore multiple and varied production outputs from well 5 can be incorporated to compute or assess the flow profile of the flowline 252. As each simulation run varies the performance or production output of each well, flow profile also varies across simulation runs and therefore overall flow profile, after numerous simulation runs, can indicate operational efficiency or characteristics of a flowline 252.

Like above, flow profiles for other flowlines 254 and 256 can also be generated or updated. As well 3 is configured to provide inputs to both flowlines 254 and 256, production output from well 3 can be divided between the flowlines based on a predefined share of output, such as 40% of the output from well 3 can go to flowline 254 and remaining 60% can go to flowline 256. As flowline 256 takes input from wells 1-3, production outputs from each of the wells 1-3 can be used to determine flow profile for flowline 256. Similarly, as flowline 254 takes input from wells 3-4, production outputs from each of the wells 3-4 can be used to determine the flow profile for flowline 254. While computing flow profile for a flowline such as 256, weights can also be accorded to each of the wells 1-3 that the flowline is connected to, based on the priority or other performance characteristics of the wells. For instance, well 1 and 2 can have higher priority over well 3, and therefore while computing flow profile for flowline 256, wells 1 and 2 can be assigned a weight of “4” and well 3 can be assigned a weight of “2”.

Flow profile for each of the flowlines 250 can be updated after every simulation run. Changes in production outputs from the wells connected to each flowline can significantly impact the flow profile or operational flow characteristics of the flowlines and therefore flow profile can depict actual functional or structural behavior for a flowline only after numerous simulation runs have been conducted and all varied conditions under which the flowline might operate have been considered. Flow profile can also be configured to indicate a well that performs more reliably and efficiently for a flowline when compared to other wells that are connected to the flowline.

Pipeline optimization system 260 can be configured use computing device 240 to take flow profile of each flowline 250 along with its respective flowline attributes as inputs and generate a risk metric for the flowline 250. The risk metric can be created or updated after each simulation run such that the updated flow profile can be factored along with the corresponding flowline attributes to generate the risk metric. Risk metric can indicate a probability that a flowline 250 can support expected flows for the simulated network. The risk metric can help understand or analyze behavior of the flowline 250 under dynamically changing characteristics of the wells that the flowline 250 is associated with and its own attributes so that appropriate measures can be taken to control the operation of the flowline 250 or of the flow model. The risk metric can also be configured to present risk probability of production output from each well over multiple simulations and variations, and can further be configured to present an overall risk probability of production for the flowline based on the behavior of the wells across random input variables.

Flowline attributes for each flowline 250 can be stored either in the memory of the computing device 240 or on a remotely accessible storage device. Furthermore, as operational, functional, or constructional characteristics of each flowline varies, flowline attributes for each flowline 250 can also be different depending on the respective flowline's functionality, material of manufacture, constructional elements, number of wells each flowline 250 is connected to, flow rate, volume of flow handled by flowline 250, among other such parameters. Varied production outputs from wells can impact flowline attributes of flowlines to which they connect, and therefore to evaluate the overall risk to which the flowline 250 is exposed, it is desirable to include flowline attributes as an input factor for assessing the risk metrics of the flowlines 250.

Risk metrics, for each flowline 250, can be computed by taking into account flowline attributes for the respective flowline 250 and using the flowline's flow profile to assign one or more risk weights to the flowline attributes, and computing a final risk metric for the flowline 250 by cumulating risks depicted by each flowline attribute. For instance, consider flow rate and MAOP as two flowline attributes for flowline 252. After each simulation run, flow profile of the flowline 252 can depict vulnerabilities or operational characteristics of the flowline 252, wherein the flow profile can be represented on a scale of 1-10, with 1 indicating weak flow profile and 10 indicating strong flow profile. Flow profile can be multiplied with each of the flowline attributes to evaluate the risk that change in each of the flowline attributes poses on the flowline 252. For instance, increase in flow rate by 3 times, can increase the pressure or lead to cracks in the flowlines and decrease in operating pressure can reduce the risk of the flowline to face a disruptive event.

Bowline risk metrics can be computed or modified after each simulation run and can change with the variation in flow profile, which in turn varies with change in production outputs from wells that the flowline is connected to. Flowline attributes, for each flowline 250, can also be defined at run-time by the pipeline optimization system 260 and can be changed for each simulation run so that impact of change in behavior or characteristics of flowline attributes, individually or collectively, can be assessed on the flowline 250. Flowline attributes can also be presented in a mathematical form and processed along with flow profile of flowline 250 through a defined equation to yield flowline risk metrics. For easier interpretation, risk metrics can be quantified to assess the level of risk and for conducting further analysis of the parameters responsible for lower or higher risk. For instance, after 1000 simulation runs, a flowline 250 can be assessed to be at 70% risk, wherein, during analysis, flowline attributes responsible for increasing the risk can be identified or highlighted and flow profile characteristics that are responsible for impacting the undesired behavior of the flowline 250 can be retrieved and processed for evaluation of potential solutions and resolutions for lowering the risk.

In an embodiment, the flowline risk metric can include cost metrics that are configured to indicate the impact of each simulation run on the flow model in terms of the cost of maintaining, pumping, treating, operating, or processing the pipeline network or individual components thereof. The risk metric module 126 can be configured to define the cost of running, managing, or servicing each flowline in terms of its flow profile and flowline attributes and quantify the cost as a risk metric. For instance, in case a defined and acceptable flow of 1150 barrels of oil per day has a cost of USD $50000, a reduced flow profile characteristic or decrease in efficiency of flowline attributes can lead to lower overall throughput and higher overall cost, wherein the magnitude of increase from the normal benchmark of USD $50000 can indicate the level of severity in the flowline network or wells or flowline attributes responsible for the inefficiency. Computation of the overall risk metric for each flowline can include the cost of gathering the oil/gas from wellheads and distributing or transporting them to the processing facilities.

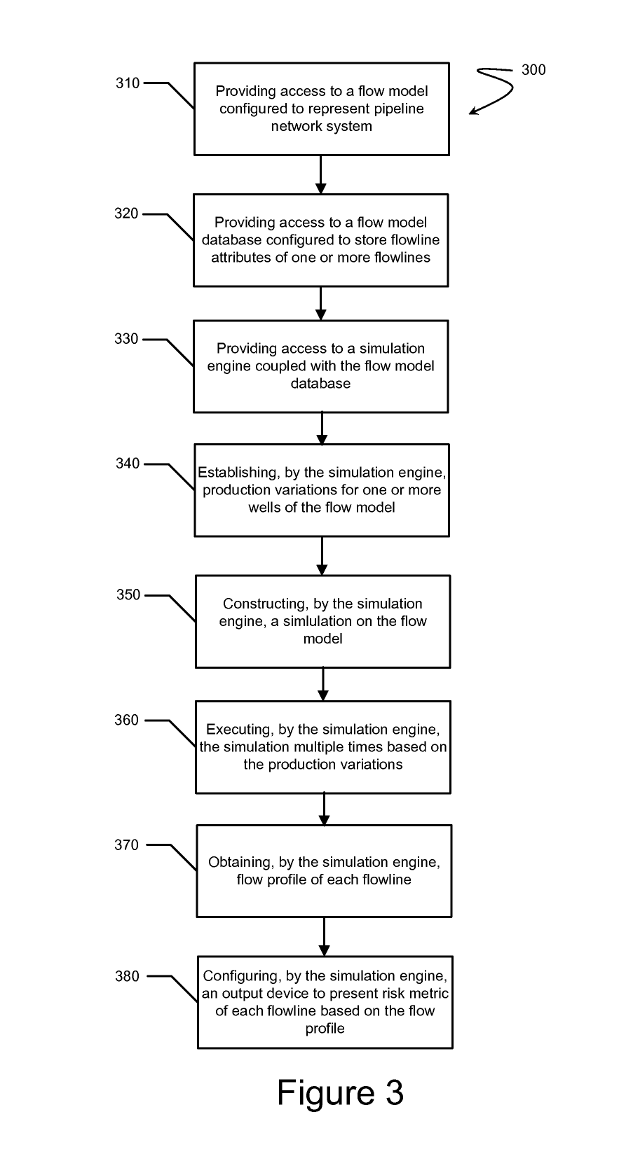

FIG. 3 presents a method 300 for pipeline network optimization and allows simulation of production outputs from wells to assess the behavior or impact of such varied production outputs on flowlines connecting to the wells and using such behavior or impact to evaluate a risk metric indicating the risk that the flowline or flow model is exposed to during operation of the pipeline network.

Step 310 can allow pipeline network optimization system to access flow model that represents the pipeline network. Data or structure relating to the flow model can be stored in database of the pipeline network optimization system or can be remotely stored, wherein the structure or data can include components that form part of the flow model including wellheads, wells, chokes, risers, downcomers, pipe fittings, multiphase separators, heat exchangers, gas compressors, pumps, H₂S removal components, CO₂ removal components, flowlines, manifold, processing facilities; attributes or parameters of such components including flowline attributes, production variation parameters for the wells, flow characteristic curve, material of manufacture, dimensions, purpose, among other such variables that characterize the flow model.

Step 320 can allow retrieval of flowline attributes of one or more flowlines of the flow model. Flowline attributes can include attributes that help define structure, function, or operation of the flowline. Flowline attributes for each flowline can be stored in the database of the flow model and can be added or removed from the list of attributes of each flowline. Furthermore, as each flowline differs in its characteristics or operation, flowline attributes for each flowline can be different. Change in one or more flowline attributes in terms of their value, significance, or priority can impact the operational behavior of the respective flowline. For instance, in case stress in a flowline is accorded higher priority than flow rate of the flowline, an increase in stress would have more detrimental impact on the performance of the flowline when compared to an equally proportional increase in flow rate of the flowline. Flow model database can also be configured to store the production variation parameters that help define factors that impact production output from wells. Production variation parameters can be different for each well and can not only impact the overall production volume from the wells but can also impact the structural or operational features of the wells. For instance, even though “stress” as a production variation parameter might not impact the production output from a well in the near term, but in the long run, the parameter can surely impact the structural layout of the well in the form of leakage or deformation of the well construction.

Step 330 allows access to a simulation engine that is operatively coupled to the database of the flow model. The simulation engine is configured to select one or more simulation models and run simulations on the flow model using random input variables and processing the variables with one or more production variation parameters of the wells. The simulation engine can be implemented in a computing device and can be configured to remotely access the flow model database and retrieve data stored in the database for further processing and running simulation.

Step 340 allows the simulation engine to retrieve one or more production variation parameters from the flow model database and select appropriate parameters for each well. The parameters can be selected based on factors such as random inputs variables to be generated by the simulation engine, flowlines to which the wells connect, production output expected from the wells, among other such factors. The simulation engine can also, for efficient and simpler processing of the simulation runs, select common parameters for each of the wells.

Step 350 allows selection of a simulation technique by the simulation engine and construction of the simulation on the flow model. In an implementation, the simulation can be construction on the entire flow model including wellheads, manifolds, among other such components, whereas, in another implementation, the simulation can be constructed on the wells of the flow model for assessment of the performance of the flowlines or impact of the variation in production output from the wells on the entire flow model. The simulation technique can either be chosen from a list of known simulation techniques or a new simulation mechanism can be devised for taking into account different production variation parameters of wells during different simulation runs or for generating random input variables with different ranges so as to test production outputs of wells for all possible cases.

Step 360 includes using the simulation technique selected by the simulation engine to generate random input variables and processing the variables with production variation parameters established for each well. The simulation can be run numerous times with same or different production variation parameters being selected for each well and different random input variables such that, for each simulation run, after processing the input variables with production variation parameters, an output from each well is generated. Such output, also referred to as production output, depicts the actual production from the well under the conditions obtained after processing the input variables with the production parameters. For instance, a higher value of random input variable can depict more extreme weightage being given to the respective production variation parameter with which the variable is processed, and therefore the production variation parameter, after processing, can put stronger or detrimental impact on the actual production volume of the well.

Step 370 includes using the simulation engine to obtain a flow profile for each flowline based on the production outputs received from wells to which the flowline is connected. Flow profile can be generated when the first simulation on the flow model is run and then can be updated after each simulation run to depict the overall reaction or impact on the flowline by change in production outputs from the wells to which it is connected. Flow profile can also be generated and stored in the flow model database after each simulation run and all generated flow profiles for a flowline can be processed together after a predefined periodic interval. In an embodiment, the flow profiles for each flowline can be averaged or can be computed in a defined equation to generate an overall flow profile for the flowline once the simulation has been completed. Apart from depicting the impact on operational efficiency of the flowline, flow profile can also be configured to present change in other resources being used in the flow model such as manifold, processing facility, wellheads, among others. Flow profile can also be used to quantify the flow rates of each flowline, overall volume of flow through the flowline, pressure or temperature characteristics, among other desired variables.

Step 380 includes using the simulation engine to compute a risk metric for one or more flowlines of the flow model based on flow profile and retrieved flowline attributes of the flowlines. The risk metric can be created or updated after each simulation run such that the updated flow profile can be factored along with the corresponding flowline attributes to generate the risk metric. The risk metric can indicate a probability that the flowline would be able to support specific volume of flow at a particular cost. The risk metric can help understand or analyze the behavior of the flowline under dynamically changing characteristics of the wells that the flowline is associated with and its own attributes so that appropriate measures can be taken to control the operation of the flowline.

Risk metric can also be represented such that reliability of the pipeline network or of each flowline is presented. Pipeline reliability can be represented through a fortification intensity index which characterizes the effect of pipeline structure, layout, diameter, value of tube wall, or construction mode of pipeline structure design on the flow model. Pipeline network reliability can also be assessed by combining flow characterization curves (probability of flow rate) received from wells after every simulation and computation of the degree of deviation from desired flowline characteristics for each flowline.

It should be appreciated that it is not only an increased magnitude of pressure, temperature, or other operational characteristics of the flow model that can cause high risk for a pipeline network. Underutilization of resources or components can also increase the risk by increasing unjustified costs, processing costs, component maintenance costs, among other such costs. For instance, as the pressure in most pipeline network systems is typically high, an underground flowline, for example a pipe, if not utilized for transportation of oil/gas, can have high inward pressure from surrounding oil/water, which may deform the pipe itself, increasing the risk metric of the flowline as well as of the flow model.

One should appreciate that although the present disclosure is being described with respect to one or more types of pipeline network systems, the inventive subject matter can be used and implemented for any compatible network system including gas pipelines, oil pipelines, computer networks, road networks, telecommunication networks, among other such gathering or injection networks. For instance, in a computer network, client devices can correspond to the wells, wherein the client devices need to access certain remote content or data, and servers can correspond to processing facilities, wherein the servers store the content that is desired to be accessed. In such computer networks, multiple resources such as routers, switches, among others are required for routing the requests from client devices to the servers and therefore it is integral to test the behavior, stability, reliability, or robustness of such routers or switches by assessing their operations under different boundary level as well as normal conditions. Assessing the behavior of such middle resources through multiple simulation runs can help the designer understand the traffic handling capability of each router/switch, individually or in combination with each other. Furthermore, in an implementation, production variation parameters of the above disclosure can correspond to client requests, wherein the client requests can be varied by processing them with random input variables, and giving the modified requests as inputs to switches or routers that they are directly or indirectly connected with. The manner in which such variations in data requests are handled by the hardware or other firmware resources of the computer network can help designers understand the bottlenecks and recommend appropriate measures to the stakeholders.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” in the sense that two networked devices are able to communicate with each other over a network, possibly through one or more intermediary devices.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A pipeline network simulation system comprising:
a memory storing a flow model of a flow network, the flow model representing flowlines capable of interconnecting wells and production facilities where the flow model further includes flowline attributes for each of the flowlines; and
a simulation engine coupled with the memory and configure to:
establish production variations for each of the wells;
construct at least one Monte Carlo simulation of the flow model based on the production variations;
obtain a flow profile for each of the flowlines from the at least one Monte Carol, the flow profile representing production flow through a corresponding flowline;
determine a risk metric associated with the at least one Monte Carlo simulation of the flow model as a function of each of the flowlines' corresponding flow profile and flow attributes; and
configure an output device to present the risk metric.

2. The system of claim 1, wherein the simulation engine is further configured to construct multiple Monte Carlo simulations, each simulation comprising a different configuration of at least one of the production variations and the flow line attributes.

3. The system of claim 2, wherein the simulation engine is further configured to determine the risk metric by aggregating risk metrics across the multiple Monte Carlo simulations of the flow model.

4. The system of claim 2, wherein the simulation engine is further configured to optimize the risk metric by altering the at least one of the production variations and the flow line attributes.

5. The system of claim 4, wherein the simulation engine is further configured to alter the at least one of the production variations and the flowline attributes according to a genetic algorithm.

6. The system of claim 1, wherein the flowline attributes include a flowline coordinate.

7. The system of claim 6, wherein the flowline coordinate comprises at least one of the following: a geographic coordinate, an elevation, a start point, an end point, and a length.

8. The system of claim 1, wherein flow model comprises a flow characteristic curve associated with each of the wells.

9. The system of claim 8, wherein the simulation engine is further configured to establish the production variations as a function of the flow characteristic curve associated with each of the wells.

10. The system of claim 8, wherein the simulation engine is configured to obtain the flow profile based on the flow characteristics curve associated with each of the wells.

11. The system of claim 8, wherein the flow characteristic curve comprises a probability distribution with respect to flow rate for a corresponding well.

12. The system of claim 1, wherein the risk metric comprises a cost metric.

13. The system of claim 10, wherein the cost metric comprises gathering cost.

14. The system of claim 1, wherein the risk metric comprises a pressure balance.

15. The system of claim 1, wherein the risk metric includes a flowline specific risk metric.

16. The system of claim 1, wherein the risk metric includes a production facility metric.

17. The system of claim 1, wherein the flowlines include at least one of the following: a pipeline, a cable, a fiber optic, and a power transmission line.
